(19) United States
(12) Patent Application Publication
(10) Pub. No.: US 2003/0005341 A1
(43) Pub. Date: Jan. 2, 2003

(54) Information processing apparatus and power management method

(75) Inventor: Yoshikazu Terunuma, Ome-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/180,314

(22) Filed: Jun. 27, 2002

(30) Foreign Application Priority Data
Jun. 29, 2001 (JP) 2001-199974

(51) Int. Cl. G06F 1/26

(52) U.S. Cl. 713/310

(57) ABSTRACT

An information processing apparatus having a device, comprises a storage unit configured to store characteristic information indicating a past operating status of the device, and a controller configured to control a power management of the device based on the characteristic information.

### CROSS-REFERENCE TO RELATED APPLICATIONS

This application is based upon and claims the benefit of priority from the prior Japanese Patent Application No. 2001-199974, filed Jun. 29, 2001, the entire contents of which are incorporated herein by reference.

### BACKGROUND OF THE INVENTION

1. Field of the Invention

The present invention relates to an information processing apparatus such as personal computers and a power management method of the information processing apparatus, particularly to an information processing apparatus having a plurality of devices and a power management method for managing a power of the plurality of devices.

2. Description of the Related Art

In recent years, in portable information processing apparatuses such as a notebook-type personal computer, various power management functions are provided for the purpose of lengthening an operating time by a battery. When the power management function is executed, power consumption of various devices such as a CPU, video adapter, hard disk drive, and modem can be reduced.

A user can set desired power management functions to be executed by a system. Thereby, the user can select a power management control in which an operation capability has priority, or a power management control in which the power saving has priority.

However, a conventional system in which the user sets power management function beforehand in this manner has the following two problems.

1) The user has to determine an operating status of an information processing apparatus, and has to perform a setting operation of the power management in accordance with the environment, so that the setting operation becomes complicated.

2) A set value determined by the user is only based on a user's sense, and it is impossible to determine whether the setting is optimum.

### BRIEF SUMMARY OF THE INVENTION

The present invention is directed to method and apparatus that substantially obviates one or more of the problems due to limitations and disadvantages of the related art.

According to an embodiment of the present invention, an information processing apparatus having a device, comprises a storage unit configured to store characteristic information indicating a past operating status of the device; and a controller configured to control a power management of the device based on the characteristic information.

Thus, an optimum power management control can automatically be executed in accordance with an operating status of the information processing apparatus.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a block diagram showing a constitution of an information processing apparatus according to the first embodiment of the present invention;

FIG. 2 is a functional block diagram of a power management/control system for use in the first embodiment;

FIG. 3 is a diagram showing one example of a database included in the power management/control system of the first embodiment;

FIGS. 4A, 4B, and 4C are diagrams showing power consumption characteristics of devices in the first embodiment;

FIG. 5 is a flowchart showing a procedure of a power management control processing of the first embodiment;

FIG. 6 is a block diagram showing a constitution of an information processing apparatus according to the second embodiment of the present invention; and

FIG. 7 is a flowchart showing a procedure of a power management control processing of the second embodiment.

### DETAILED DESCRIPTION OF THE INVENTION

An embodiment of an information processing apparatus according to the present invention will now be described with reference to the accompanying drawings.

### First Embodiment

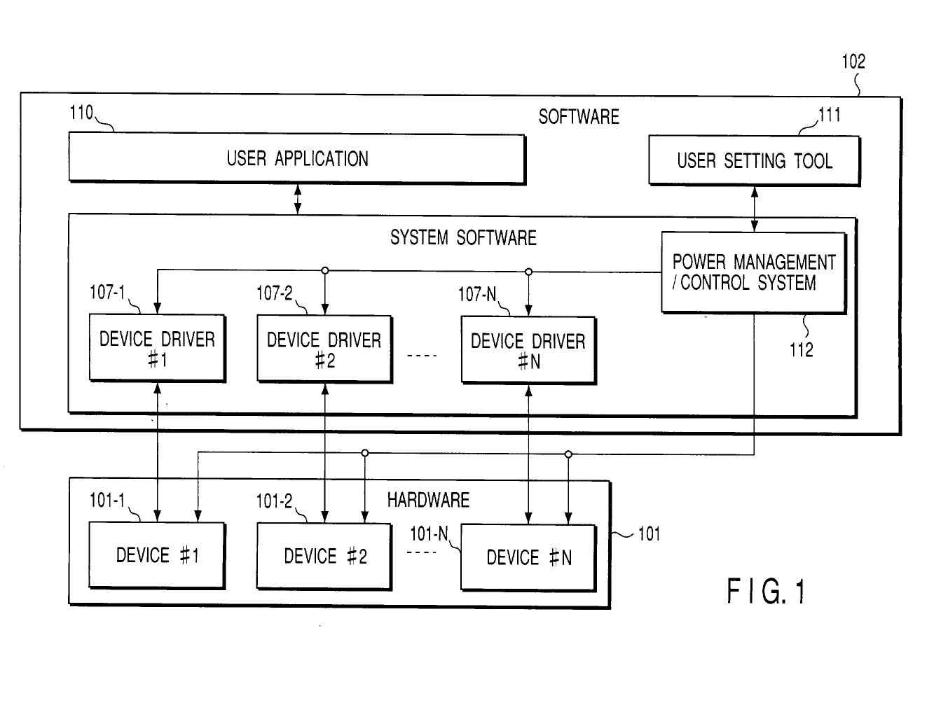

FIG. 1 shows a constitution of the information processing apparatus according to the first embodiment of the present invention. In this embodiment, the information processing apparatus is a portable computer such as a notebook-type personal computer, and can be operated by a battery. The information processing apparatus is roughly divided into a hardware unit 101 and a software unit 102.

The hardware unit 101 comprises a plurality of devices (#1, #2 to #N) 101-1, 101-2, . . . 101-N. Examples of the devices 101-1, 101-2, . . . 101-N include a CPU, memory, chip set, video adapter, hard disk drive, display monitor, USB controller, IEEE 1394 I/F controller, modem, LAN controller, and radio communication module.

The software unit 102 comprises a system software 103, user application 110, user setting tool 111, and the like. The system software 103 is a program group for controlling the hardware unit 101, such as an operating system and utility program. A plurality of device drivers (#1, #2 to #N) 107-1, 107-2, . . . 107-N, a power management/control system 112, and the like are provided. The device drivers (#1, #2 to #N) 107-1, 107-2, . . . 107-N manage and control the plurality of corresponding devices (#1, #2 to #N) 104-1, 104-2, 104-N. In this case, one device driver may manage plural devices.

The power management/control system 112 is a program for performing the power management control of the information processing apparatus, and controls operating speeds of the respective devices 104-1, 104-2, . . . 104-N or an on/off of a power supply in accordance with a set value for a power saving control designated by a user. Examples of the set value include 1) the operating speed of the CPU (clock frequency of the CPU), 2) time required from when an idle state is detected until the power supply of the corresponding device is turned off, and 3) designation of a use device and a nonuse device.

Moreover, the power management/control system 112 also has a function (optimization mode) of optimizing the set value for the power saving control. In the optimization mode, even when the user does not perform an operation of designating the set value for the power saving control, the power management/control system 112 automatically selects the optimum value. To realize the function, the power management/control system 112 detects the present operating status of the hardware unit 101 at a constant time interval. In a detection method, information is obtained from the device drivers 107-1, 107-2, . . . 107-N corresponding to the respective devices 104-1, 104-2, . . . 104-N, or the information is obtained directly from the devices 104-1, 104-2, . . . 104-N if necessary. Thereby, it is possible to grasp a tendency of operating status of each of the devices.

The power management/control system 112 predicts the set value for an optimum power saving control based on the tendency of the past operating status of the information processing apparatus every predetermined time period (e.g., every five minutes), and controls the set value for the power saving control based on the predicted result. That is, the system predicts the future operating status of the devices 104-1, 104-2, . . . 104-N, determines the set value for the power saving control, and controls the operating speeds of the respective devices 104-1, 104-2, . . . 104-N or the on/off of the power supply based on the determined set value. Even in this case, similarly as during the obtaining of the information, the system sets the value via the device drivers 107-1, 107-2, . . . 107-N corresponding to the respective devices 104-1, 104-2, . . . 104-N, or directly controls the devices 104-1, 104-2, . . . 104-N if necessary.

The user-setting tool 111 is an interface for allowing the user to designate the set value for the power saving control. Moreover, by using the user-setting tool 111, one of the optimization mode for automatically performing the power saving control, and a user-setting mode for performing the power saving control in accordance with the user setting can be selected. Even when the optimization mode is selected, the user can use the user-setting tool 111 to freely set the individual set values again.

### Power Management/control System 112

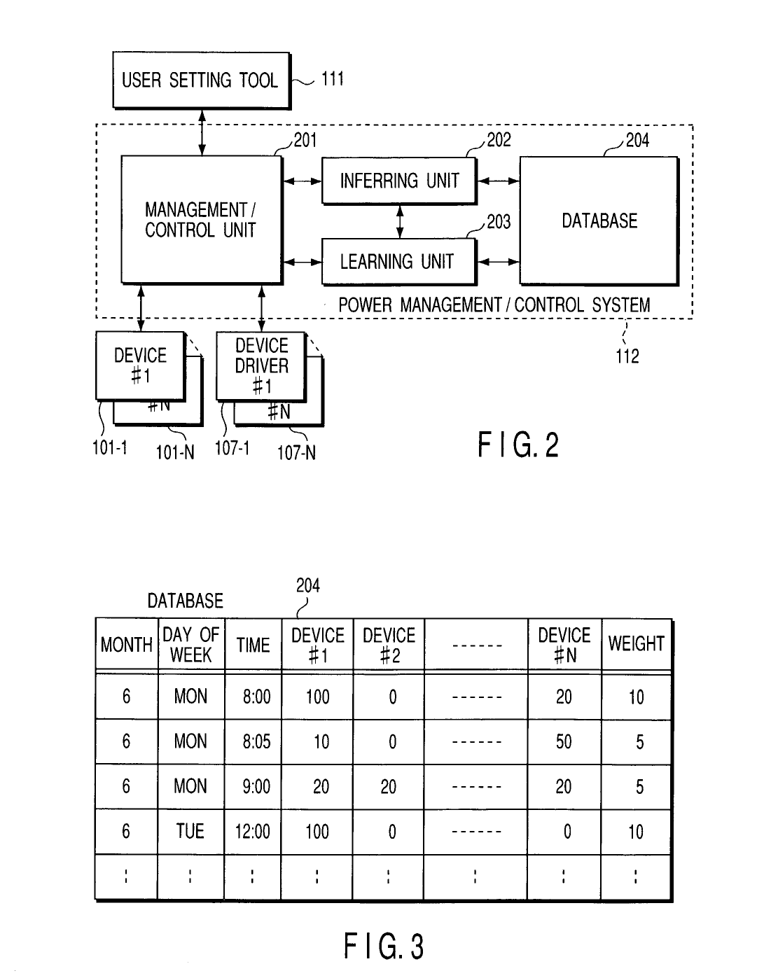

FIG. 2 shows a functional constitution of the power management/control system 112. The power management/control system 112 includes a management/ control unit 201, inferring unit 202, learning unit 203, and database 204.

The management/control unit 201 performs a power management control, has an interface with the respective devices 104-1, 104-2, . . . 104-N and device drivers 107-1, 107-2, . . . 107-N, and also has an interface with the user via the user setting tool 111. This management/control unit 201 executes the obtaining of operating status of the respective devices 104-1, 104-2, . . . 104-N and the power management control of the respective devices 104-1, 104-2, . . . 104-N.

The inferring unit 202 predicts the set value for the optimum power saving control based on characteristic information that indicates the past operating status of the information processing apparatus for every predetermined time period and is stored in the database 204. The unit 202 predicts the future operating status of the respective devices 104-1, 104-2, . . . 104-N for a next time period based on the present operating status of the respective devices 104-1, 104-2, . . . 104-N, and the past operating status of the respective devices 104-1, 104-2, . . . 104-N which is indicated by the characteristic information. The predicted result is notified to the management/control unit 201, and the power management control is executed based on the predicted result by the management/control unit 201.

The learning unit 203 learns the operating status of the information processing apparatus, and generates the above-described characteristic information. That is, the learning unit 203 analyzes the history of the past operating status of the information processing apparatus, which is obtained by the management/control unit 201 and stored in the database 204. Moreover, the leaning unit 203 generates the characteristic information indicating the tendency of the operating status of each of the device drivers 107-1, 107-2, . . . 107-N for every predetermined time period and stores the characteristic information into the database 204.

### Characteristic Information

FIG. 3 shows one example of the characteristic information stored in the database 204. The characteristic information has time scales “month”, “day of the week”, and “time”, and the operating status of the respective device drivers 107-1, 107-2, . . . 107-N, and weight values are registered for every predetermined time period (e.g., every five minutes) designated by the time scales.

For example, in an example of FIG. 3, it is shown that a time period from time 8:00 to 8:05 on Monday (MON) in June, the device #1 is fully used (100%), the device #2 is not used at all (0%), and the device #N is partly used (20%). It is shown that a time period from time 9:00 to 9:05 on Monday (MON) in June, all the devices #1 to #N are partly used (20%). The operating statuses of the respective devices are represented by numeric values of 0 to 100% so that the tendency of the operating status (use amount of resource) of the CPU or memory can also be recorded. Depending on the device, there are sometimes only two states ON and OFF.

A weight value indicates a frequency of occurrence of the corresponding status. That is, it can be assumed that with a larger weight value, a probability of occurrence of the corresponding operating status increases at the point of time.

### Operating Status of Devices

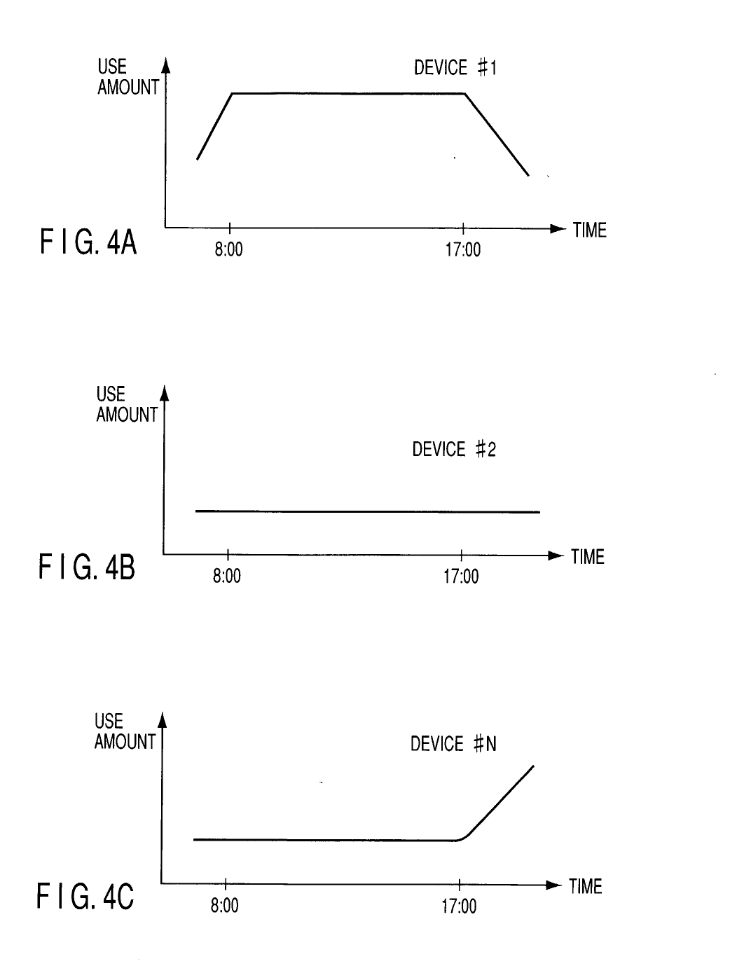

FIGS. 4A to 4C show one example of a change of the operating status of each of the devices 104-1, 104-2, . . . 104-N. When the same user uses the information processing apparatus, the operating status of each device depends on a user's action pattern.

For example, assuming that the user goes to work at 8:00 and leaves work at 17:00, as shown in FIG. 4A, the operating status of the devices such as the CPU, memory, and LAN of the information processing apparatus has a large value between 8:00 and 17:00, but the value of the operating status extremely drops before 8:00 and after 17:00. On the other hand, as shown in FIG. 4B, some devices such as the IEEE 1394 I/F, and modem are hardly used between 8:00 and 17:00. Furthermore, when the user comes home, the user uses the devices such as the IEEE 1394 I/F and modem in many cases. Therefore, as shown in FIG. 4C, the value of the operating status sometimes rises after 17:00.

Moreover, working days of Monday through Friday have the above-described tendency, but Saturday and Sunday sometimes have the operating status very different from those of Monday through Friday.

Therefore, as described with reference to FIG. 3, the above-described characteristic information is generated and recorded which indicates the tendency of the operating status of each device with the time scales of the “month”, “day of the week”, and “time”. Thereby, it is possible to highly precisely predict the operating status of each device by the day of the week and time period from the characteristic information.

### Power Management Control Processing

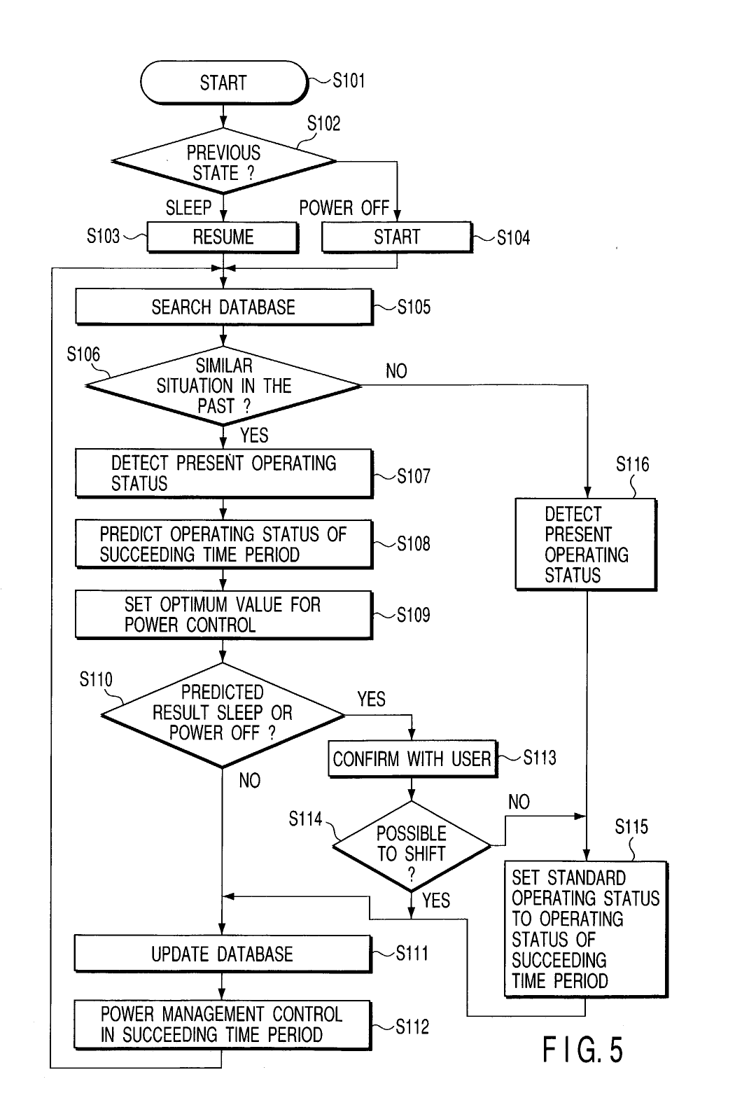

A procedure of a power management control processing executed by the power management/control system 112 during the optimization mode will next be described with reference to a flowchart of FIG. 5.

The power management/control system 112 is started, when the user turns on the power supply of the information processing apparatus (step S101). A flow of the processing to be executed differs with the previous system status. Therefore, the power management/control system 112 first determines whether the previous system status is a sleep state or a power off (shutdown) state (step S102). Here, the sleep state means that a system context necessary for restoring a system-operating environment is saved in a main memory or a hard disk, and subsequently the power supply of the system is turned off.

In the sleep state, the power management/control system 112 executes a resume processing of restoring the system context and restoring the system-operating environment just before the power off (step S103). In the power off (shutdown) state, a usual boot up processing for starting the operating system is executed (step S104).

The information processing apparatus is brought into an operative state in this manner. While the information processing apparatus is in the operative state, the power management/control system 112 repeatedly executes the following processing.

The power management/control system 112 first searches the database 204 to find characteristic information corresponding to the present time period and a succeeding time period (steps S105, S106). If it is 8:02, Monday of June, characteristic information corresponding to the present time period from 8:00 to 8:05 and the succeeding time period from 8:05 to 8:10 is found. If it is 9:04, Monday of June, characteristic information corresponding to the succeeding time period from 9:05 to 9:10 is not found.

When the characteristic information is found (YES in step S106), the power management/control system 112 detects the present operating status of the respective devices 104-1, 104-2, . . . 104-N (step S107). The system 112 predicts the operating status of the respective devices 104-1, 104-2, . . . 104-N for the succeeding time period based on the detected present operating status of the respective devices 104-1, 104-2, . . . 104-N and the characteristic information in the database 204 indicating the past operating status corresponding to the present time period and the succeeding time period, and determines the set value for the optimum power saving control for each of the devices 104-1, 104-2, . . . 104-N (steps S108, S109).

For example, when the detected operating status of the respective devices 104-1, 104-2, . . . 104-N agrees with the past operating status corresponding to the present time period, it can be assumed that the past operating status corresponding to the succeeding time period will be happened with a high probability. For the device whose past operating status is different from the detected actual status, the probability at which the status shifts to the past operating status corresponding to the succeeding time period is assumed to be low. The weight value concerning the past operating status will also be considered.

In this manner, the optimum value for the power saving control is set based on the determination. In this case, in a predicted operating status where the operations of all the devices 104-1, 104-2, . . . 104-N are stopped, the information processing apparatus is expected to shift to the sleep state or the power off state.

Subsequently, the power management/control system 112 determines whether the predicted operating status is the sleep state or the power off state (step S110). When the predicted operating status is the sleep state or the power off state (YES in the step S110), the power management/control system 112 inquires of the user as to whether the apparatus may shift to the sleep state or power off state by a screen display, and the like (step S113). If the apparatus directly shifts to the sleep state or power off state, this supposedly sometimes goes against a user's intention. By a response from the user, the system determines whether or not the apparatus can shift to the sleep state or the power off state (step S114). Of course, the power off state may be excluded beforehand from the predicted operating status. When there is no response from the user concerning the inquiry, the apparatus may automatically shift to the sleep state.

If the user does no permit a shift to the sleep state or power off state (NO in step S114), a predetermined standard operating status is set to the operating status for the succeeding time period (step S115).

When the characteristic information is not found (NO in step S106), the power management/control system 112 detects the present operating status of the respective devices 104-1, 104-2, . . . 104-N (step S116). Then, a predetermined standard operating status is set to the operating status for the succeeding time period (step S115).

After steps S110, S114, and S115, the power management/control system 112 updates the database 204 by rewriting the characteristic information indicating the operating status corresponding to the present time period and the succeeding time period (step S111). Thereafter, during the succeeding time period, the power management control is executed based on the set value (step S112).

The end of the processing is not shown in the flowchart of FIG. 5. However, if the future operating status is the power off state or the sleep state, the processing is completed by the shift to the power off state or the sleep state.

As described above, according to the first embodiment, the information processing apparatus having a plurality of devices generates the characteristic information indicating the tendencies of the operating status of the plurality of devices by the month, day of the week, and time period based on the history of the operating status concerning each of the devices; obtains the tendency of the operating status of each device corresponding to the present month, day of the week, and time period from the characteristic information; predicts the operating status of each device of the succeeding time period; and controls the on/off of the power supply of each device or the operating speed of the device based on the predicted operating status of the device.

According to the information processing apparatus, when the daily operating status by the user is learned, the optimum power management control suitable for the operating status can be realized. Particularly, when the tendency of the operating status is grasped for the month, day of the week, and time period, and the suitable power management control is performed, the setting of the power management can constantly be optimized. Furthermore, since the on/off of the power supply or the operating speed of the device is controlled individually for the devices, it is possible to eliminate any useless power consumption by the actually unused device.

The characteristic information for at least each time period may be registered, and it is unnecessary to register the characteristic information for each month or each day of the week beforehand.

### Second Embodiment

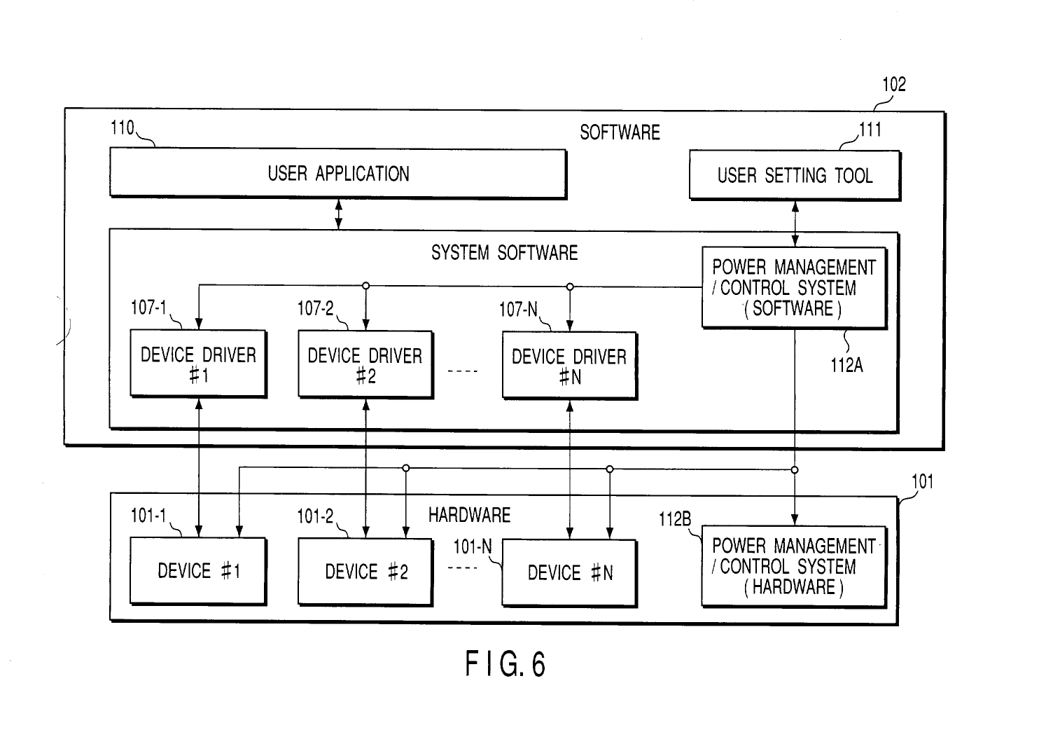

FIG. 6 shows the constitution example of the information processing apparatus according to the second embodiment of the present invention. The information processing apparatus has a constitution different from the constitution of FIG. 1 in that a power management/control system 112B constituted of hardware is provided in addition to a power management/control system 112A constituted of software, and the other respects are similar to those of FIG. 1. The power management/control system 112A constituted of software corresponds to the power management/control system 112 of FIG. 1. The power management/control system 112B constituted of hardware has an interface with the power management/control system 112A, is managed/controlled by the power management/control system 112A, and manages/controls the respective devices 104-1, 104-2, . . . 104-N.

The power management/control system 112B comprises a controller for generating a wakeup signal to change the information processing apparatus to a power on state from the sleep state or the power off state at a set alarm time. The power management/control system 112A sets the alarm time to generate the wakeup signal in the power management/control system 112B. That is, the power management/control system 112A predicts a time to turn on the power supply of the information processing apparatus based on the above-described characteristic information, and sets the predicted time as the alarm time in the power management/control system 112B. Even when the power supply of the information processing apparatus is turned off, the power continues to be supplied to the power management/ control system 112B from the battery, and the like, and the wakeup signal is automatically generated at the alarm time. This brings the information processing apparatus in the power on state.

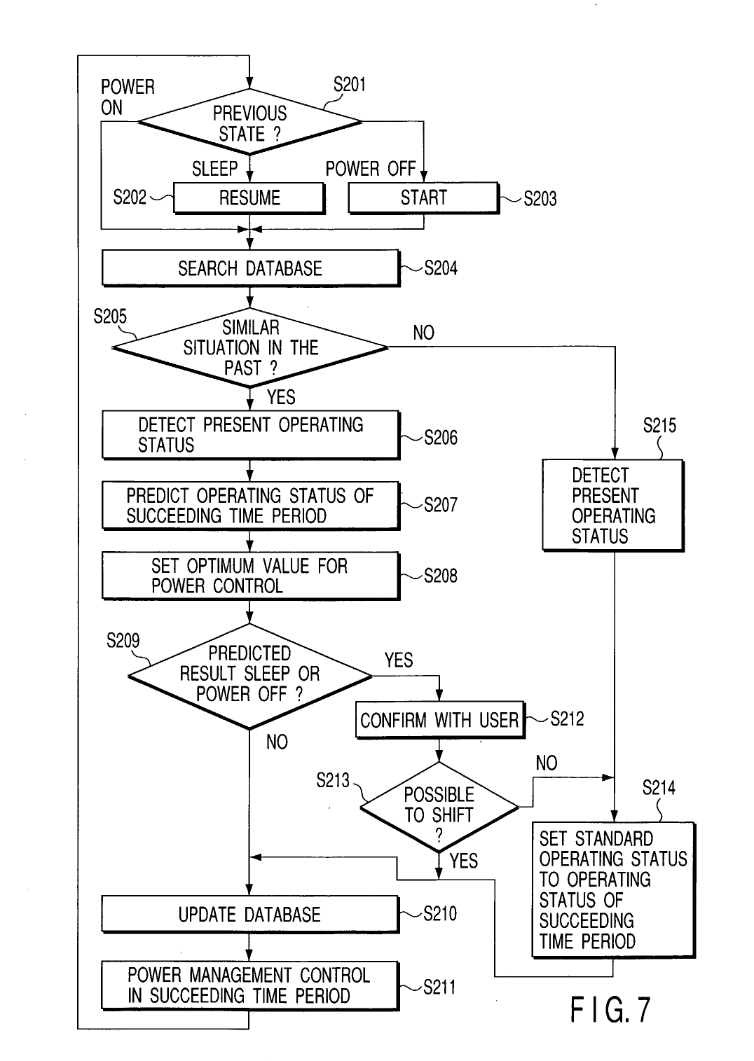

FIG. 7 is a flowchart showing the flow of the processing operation by the power management/control systems 112A and 112B.

The flowchart of FIG. 7 shows the flow as seen from the user, and therefore the power off status is included. In the constitution of FIG. 6, the status of the power off, which is visible from the user, is also one of the managed statuses. Therefore, the flow of the processing operation does not have a starting point or an endpoint in the flowchart of FIG. 7. The other processing operations are equal to those of FIG. 5.

Even in this embodiment, since the flow of the processing to be executed differs with the previous system status, it is first determined whether the previous system status was the sleep state, or the power off (shutdown) state, or was maintained in the power on state (step S201). The resume processing is executed, when the status was the sleep state (step S202). The boot up processing is executed, when the status was the power off (shutdown) state (step S203).

The database 204 is searched to find characteristic information corresponding to the present time period and a succeeding time period (steps S204, S205).

When the characteristic information is found (YES in step S205), the present operating status of the respective devices 104-1, 104-2, . . . 104-N is detected (step S206). The operating status of the respective devices 104-1, 104-2, . . . 104-N for the succeeding time period is predicted based on the detected present operating status of the respective devices 104-1, 104-2, . . . 104-N and the characteristic information in the database 204 indicating the past operating status corresponding to the present time period and the succeeding time period, and the set value for the optimum power saving control for each of the devices 104-1, 104-2, . . . 104-N is determined (steps S207, S208).

In this manner, the optimum value for the power saving control is set based on the determination. In this case, in a predicted operating status where the operations of all the devices 104-1, 104-2, . . . 104-N are stopped, the information processing apparatus is expected to shift to the sleep state or the power off state.

Subsequently, it is determined whether the predicted operating status is the sleep state or the power off state (step S209). When the predicted operating status is the sleep state or the power off state (YES in the step S209), the user is inquired as to whether the apparatus may shift to the sleep state or power off state by a screen display, and the like (step S212). By a response from the user, it is determined whether or not the apparatus can shift to the sleep state or the power off state (step S213). Of course, the power off state may be excluded beforehand from the predicted operating status. When there is no response from the user concerning the inquiry, the apparatus may automatically shift to the sleep state.

If the user does no permit a shift to the sleep state or power off state (NO in step S213), a predetermined standard operating status is set to the operating status for the succeeding time period (step S214).

When the characteristic information is not found (NO in step S205), the present operating status of the respective devices 104-1, 104-2, . . . 104-N is detected (step S215). Then, a predetermined standard operating status is set to the operating status for the succeeding time period (step S214).

After steps S209, S213, and S214, the database 204 is updated by rewriting the characteristic information indicating the operating status corresponding to the present time period and the succeeding time period (step S210). Thereafter, during the succeeding time period, the power management control is executed based on the set value (step S211).

As described above, even according to the second embodiment, when the daily operating status by the user is learned, the optimum power management control suitable for the operating status can be realized. Particularly, when the tendency of the past operating status is grasped by the day of the week, and the time period, and the suitable power management control is performed, the setting of the power management can constantly be optimized. Furthermore, since the on/off of the power supply or the operating speed of the device is controlled individually for the devices 104-1, 104-2, . . . 104-N, it is possible to eliminate any useless power consumption by the actually unused device.

The characteristic information may be registered for at least each time period, and it is unnecessary to register the characteristic information beforehand for each month, or each day of the week.

As described above, according to the present invention, it is possible to realize the optimum power management control suitable for the operating status of the information processing apparatus by the user.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, all the power management controls of the embodiments can be realized by software except for the generation of the wakeup signal. Therefore, when the computer program for allowing the computer to execute the procedure of the power management control is stored in a computer readable storage medium, and when this program is simply introduced and executed in the usual computer through the storage medium, an effect can easily be obtained similarly as the embodiments.

What is claimed is:

1. An information processing apparatus having a device, comprising:
a storage unit configured to store characteristic information indicating a past operating status of the device; and
a controller configured to control a power management of the device based on the characteristic information.

2. The apparatus according to claim 1, further comprising:
a detector configured to periodically detect an operating status of the device; and
a learning unit configured to analyze the detected operating status of the device and obtain the characteristic information.

3. The apparatus according to claim 1, wherein the controller comprises:
a detector configured to detect a present operating status of the device and predict a feature operating status of the devices based on the detected present operating status and the characteristic information; and
a power controller configured to control the power management of the device based on the predicted feature operating status of the device.

4. The apparatus according to claim 3, wherein
the power controller controls on/off of a power supply of the device.

5. The apparatus according to claim 3, wherein the power controller controls an operating speed of the device.

6. The apparatus according to claim 1, further comprising:
a wakeup signal generator configured to generate a wakeup signal for changing the information processing apparatus to a power-on state from a sleep state at a predetermined time,
wherein the controller comprises:
a predicting unit configured to predict, based on the characteristic information, a time at which a power of the information processing apparatus is turned on; and
a determining unit configured to determine the predetermined time based on the predicted time.

7. The apparatus according to claim 1, wherein the controller comprises:
a predicting unit configured to predict, based on the characteristic information, a time at which the information processing apparatus is changed to a sleep state from an operative state; and
a unit configured to change the information processing apparatus to the sleep state from the operative state at the predicted time.

8. An information processing apparatus having a device, comprising:
a storage unit configured to store characteristic information indicating a past operating status of the device by a day of week and a time of day;
a predicting unit configured to predict a feature operating status of the device based on the characteristic information; and
a controller configured to control a power management of the device based on the predicted feature operating status.

9. An information processing apparatus in which a power management is controlled in accordance with a power saving control signal, the apparatus comprising:
a storage unit configured to store characteristic information indicating an operating status of the information processing apparatus;
a predicting unit configured to predict a feature operating status of the information processing apparatus based on the characteristic information; and
a controller configured to generate the power saving control signal based on the predicted operating status.

10. A power control method for an information processing apparatus having a device, the method comprising:
storing characteristic information indicating a past operating status of the device; and
controlling a power management of the device based on the characteristic information.

11. The method according to claim 10, further comprising:
periodically detecting a present operating status of the device; and
analyzing the detected present operating status of the device and obtaining the characteristic information.

12. The method according to claim 10, wherein the controlling comprises:
detecting a present operating status of the device and predicting a feature operating status of the device based on the detected present operating status and the characteristic information; and
controlling the power management of the device based on the predicted operating status of the device.

13. The method according to claim 12, wherein the controlling comprises controlling on/off of a power supply of the device.

14. The method according to claim 12, wherein the controlling comprises controlling an operating speed of the device.

15. The method according to claim 10, further comprising:
generating a wakeup signal for changing the information processing apparatus to a power-on state from a sleep state at a predetermined time, wherein the controlling comprises:
predicting, based on the characteristic information, a time at which a power of the information processing apparatus is turned on; and
determining the predetermined time based on the predicted time.

16. The method according to claim 10, wherein the controlling comprises:
predicting a time at which the information processing apparatus is changed to a sleep state from an operative state based on the characteristic information; and
setting the information processing apparatus to the sleep state from the operative state at the predicted time.

17. A power control method for an information processing apparatus in which a power management is controlled in accordance with a power saving control signal, the method comprising:
storing characteristic information indicating an operating status of the information processing apparatus;
predicting a feature operating status of the information processing apparatus based on the characteristic information; and
generating the power saving control signal based on the predicted operating status.
